(19) United States
(12) Patent Application Publication
(10) Pub. No.: US 2007/0276779 A1
(43) Pub. Date: Nov. 29, 2007

(54) METHOD FOR AVOIDING ORPHAN ENTRIES IN CASCADE DELETE IN A CONFIGURATION MANAGEMENT DATABASE

(75) Inventors: Ronald B. Baker, Wake Forest, NC (US); Ling-Ching W. Tai, Cary, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/419,780

(22) Filed: May 23, 2006

(51) Int. Cl. G06F 17/30

(52) U.S. Cl. 707/1

(57) ABSTRACT

Disclosed herein is a configuration management database including: a managed element table including a managed element identifier field, an actual class field, a name field, and a superior identifier field; a operating system table including the managed element identifier field and an operating system type field; and a computer system table including the managed element identifier field, a processor family field, a manufacturer field, a machine type field, a model field, and a serial number field, wherein the managed element identifier field is a primary key for the managed element table and a foreign key for the operating system table and the computer system table.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

The present disclosure relates generally to configuration management database design and more specifically to a method for avoiding orphan entries in cascade delete.

2. Description of the Related Art

The primary goal for a Configuration Management Database (or CMDB) is to provide support for configuration items, or resources, as defined by the IT Infrastructure Library (ITIL). All resource types in a CMDB are defined within a hierarchy of classes, where the top of the hierarchy is a class called managed element. Accordingly, every CMDB resource is a type of managed element and will have a common set of attributes, no matter what the type of resource. These common attributes include a globally unique ID, an identifying name, the actual class type, a label, and a description.

Some types, or classes, of CMDB resources have additional attributes, which can vary by class. For example, an operating system has additional attributes like operating system type, operating system version, host name, total memory, and total physically attached storage. In another example, a computer system has additional attributes like manufacturer, machine type, model, serial number, processor family, and so on. It is a common database design practice to store the common attributes in one table and resource-specific attributes in separate tables as shown in FIG. 1, which illustrates typical database design for a CMDB. The primary keys (PK) of both the computer system and the operating system tables are foreign keys (FK) back into the managed element table. The foreign key constraint is usually set to “cascade delete.” This setting means when a computer system or operating system is deleted from the managed element table, its associated computer system or operating system entry stored in the computer system or operating system table will also be deleted.

In addition to representing and storing relationships between resources, another important purpose of the CMDB is to provide a correlation mechanism between management products. For example, two management products might “discover” the existence of a single computer system, but might obtain different sets of attributes from that computer system. The management products may or may not have gathered the same identifying attributes, which means the CMDB receiving the information may not realize that they are referring to the same item. The ability to evaluate the obtained attributes from different products and make this realization is called “correlation.” There are many ways to perform this evaluation, from simple attribute name and value matching to more complicated parsing. In all cases, it requires the use of a data model that formally defines the ways in which each type of resource, or class, is identified (e.g., using naming rules).

The naming rules list all the potential attributes that provide identifying characteristics, the combination of those attributes that are needed to identify the resource, and what the context is that makes that combination unique. For example, there might be a rule that says that combining “Manufacturer”, “Machine Type”, “Model”, and “Serial Number” give a unique identification of a computer system. However, for some types of resources, a simple combination of attributes is not sufficient to uniquely identify a resource without the inclusion of some other context. For example, the drive letter (like “C”) of a logical disk is not sufficient to give a unique identification. However, the drive letter is unique within the context of an operating system instance. That means the naming rule of a logical disk uses an operating system as the naming context, which is refer to as a “superior.” Adding a superior to a naming rule addresses the unique identification problem. However, it introduces additional challenge in deleting a superior from the database. In other words, when a superior is deleted, all resources named after the superior must also be deleted.

### SUMMARY

The shortcomings of the prior art are overcome and additional advantages are provided through the provision of test generation methods.

Exemplary embodiments include a configuration management database including: a managed element table including a managed element identifier field, an actual class field, a name field, and a superior identifier field; a operating system table including the managed element identifier field and an operating system type field; and a computer system table including the managed element identifier field, a processor family field, a manufacturer field, a machine type field, a model field, and a serial number field, wherein the managed element identifier field is a primary key for the managed element table and a foreign key for the operating system table and the computer system table.

Exemplary embodiments also include a method for avoiding orphan entries in cascade delete in a configuration management database including deleting an element from a managed element table, the element including a managed element identifier and deleting all entries in the managed element table that include the managed element identifier in a superior element field.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that avoids orphan entries in cascade delete in a configuration management database.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a database design for a traditional configuration management database;

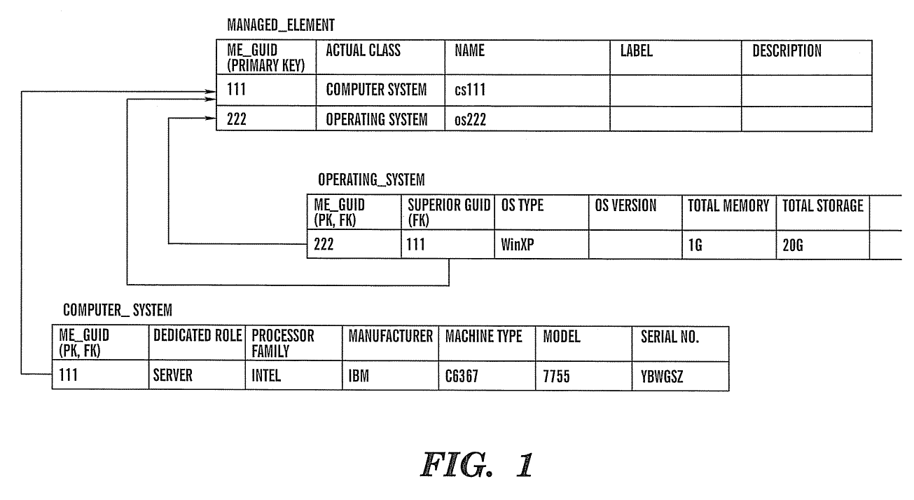

FIG. 2 illustrates a database design for a configuration management database in accordance with exemplary embodiments; and

FIG. 3 illustrates a flowchart for a method of avoiding orphan entries in cascade delete in accordance with exemplary embodiments.

The detailed description explains the preferred embodiments of the invention, together with advantages and features, by way of example with reference to the drawings.

### DETAILED DESCRIPTION

Referring now to the Figures for the purpose of illustration, it is to be understood that standard components or features that are within the purview of an artisan of ordinary skill and do not contribute to the understanding of the various exemplary embodiments are omitted from the Figures to enhance clarity.

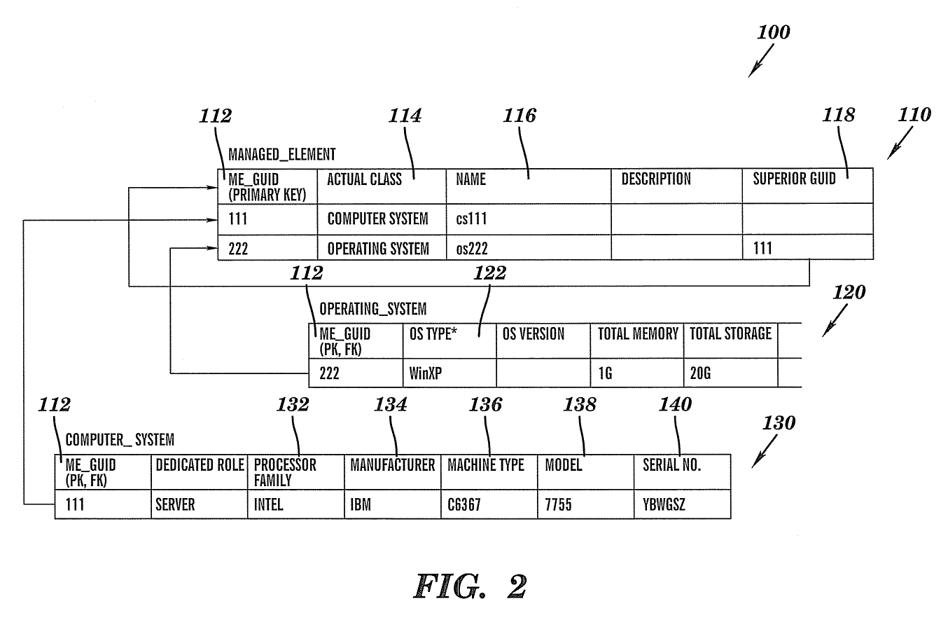

FIG. 2 illustrates a configuration management database 100 in accordance with exemplary embodiments. The configuration management database includes a managed element table 110, an operating system table 120, and a computer system table 130. The managed element table 110 includes a managed element identifier field 112, an actual class field 114, a name field 116, and a superior identifier field 118. The operating system table 120 includes the managed element identifier field 112 and an operating system type field 122. The a computer system table 130 includes the managed element identifier field 112, a processor family field 132, a manufacturer field 134, a machine type field 136, a model field 138, and a serial number field 140.

In exemplary embodiments, the managed element identifier field 112 is a primary key for the managed element table 110 and a foreign key for the operating system table 120 and the computer system table 130. The managed element identifier 112 is a unique identifier that is assigned to each element contained within the configuration management database 100. The actual class field 114 contains the actual class of each managed element (e.g., computer system, operating system, or the like). The name field 116 contains the name corresponding to each managed element (e.g., cs111, os222, or the like). The superior identifier field 118 contains the unique identifier assigned to the superior class of the managed element. In other words the superior identifier field 118 contains the unique identifier assigned to the class above the managed element in the hierarchical class structure. For example, an operating system may have the unique identifier of a computer system that the operating system is installed on in its superior identifier field 118.

In exemplary embodiments, the operating system type field 122 includes the type of the operating system (e.g., Windows XP, OS X, Linux, or the like). The processor family field 132 includes the type, or family, of the processor included in the computer system (e.g., Intel, PowerPC, and the like). The manufacturer field 134 includes the manufacturer of the computer system (e.g., IBM, Dell, Apple, or the like). The machine type field 136, a model field 138, and a serial number field 140.

Typically, when a computer system 111 is deleted from the managed element table 110, the computer system 111 entry in the computer system table 130 table is deleted; and the associated operating system 222 entry in the operating system table 120 is also deleted. However, the operating system 222 entry in the managed element table 110 is not typically deleted and becomes an orphan entry. Currently, these orphan entries are deleted from the configuration management database 100 manually or periodically via a database cleanup utility.

In exemplary embodiments, during the configuration management database 100 name reconciliation process, the entry for a superior identifier may require modification. When this occurs, all managed elements that contain the superior identifier must be updated to reflect this change. As the superior identifier is defined in the resource-specific tables of classes that have a superior, this requires the name reconciliation process to maintain information about which classes having naming rules that require a superior and which tables are affected by the superior name change.

In another exemplary embodiment, when the computer system 111 is deleted from the managed elements table 110, all related entries including operating system entry 222 in the managed elements table 110 will be automatically deleted. One advantage to this approach is that there is no need to write a database cleanup utility to periodically delete orphan entries. The superior identifier column 118 of all classes is defined in the managed elements table 110, which significantly simplifies the configuration management database 100 name reconciliation process.

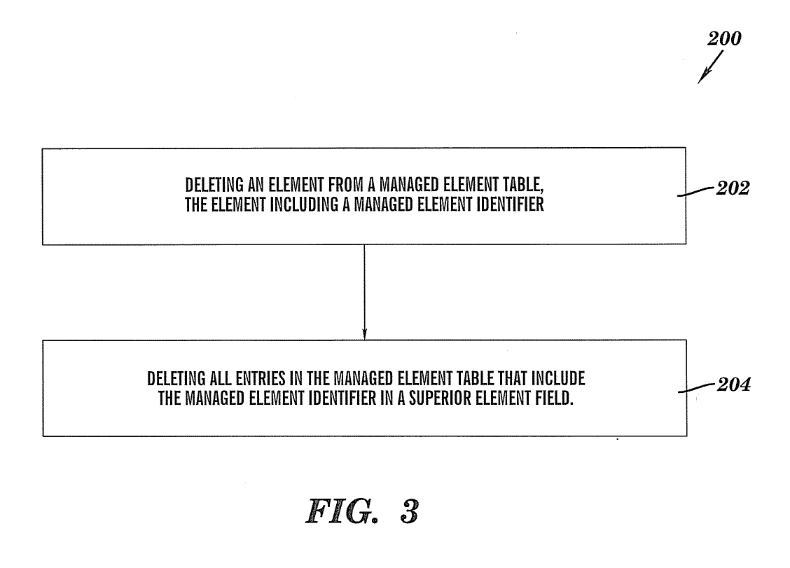

Referring now to FIG. 3, a flowchart of a method 200 for avoiding orphan entries in cascade delete in accordance with exemplary embodiments is illustrated. The first step in the method 200 is deleting an element from a managed element table, the element including a managed element identifier, as shown at process block 202. The next step in the method 200 is to delete all entries in the managed element table that include the managed element identifier in a superior element field, as shown at process block 204.

The capabilities of the present invention can be implemented in software, firmware, hardware or some combination thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A configuration management database design comprising:
a managed element table comprising a managed element identifier field, an actual class field, a name field, and a superior identifier field;
a operating system table comprising the managed element identifier field and an operating system type field; and
a computer system table comprising the managed element identifier field, a processor family field, a manufacturer field, a machine type field, a model field, and a serial number field, wherein the managed element identifier field is a primary key for the managed element table and a foreign key for the operating system table and the computer system table.

2. The configuration management database design of claim 1, wherein the managed element table further comprises a description field.

3. The configuration management database design of claim 2, wherein the operating system table further comprises a total memory field.

4. The configuration management database design of claim 3, wherein the operating system table further comprises a total storage field.

5. A method for avoiding orphan entries in cascade delete in a configuration management database comprising:
deleting an element from a managed element table, the element including a managed element identifier in an managed element identifier field; and
deleting all entries in the managed element table that include the managed element identifier in a superior element field.

6. The method of claim 5, wherein the managed element table further comprises an actual class field and a name field.

7. The method of claim 6, further comprising deleting the element from a computer system table that includes the element identifier in the managed element identifier field.

8. The method of claim 6, further comprising deleting the element from a operating system table that includes the element identifier in the managed element identifier field.

9. A configuration management database design comprising:
a managed element table comprising a managed element identifier field, an actual class field, a name field, a description field, and a superior identifier field;
a operating system table comprising the managed element identifier field, a total memory field, a total storage field, and an operating system type field; and
a computer system table comprising the managed element identifier field, a processor family field, a manufacturer field, a machine type field, a model field, and a serial number field,
wherein the managed element identifier field is a primary key for the managed element table and a foreign key for the operating system table and the computer system table, and
wherein the superior identifier field includes a managed element identifier corresponding to a superior managed element of a managed element included in the managed element identifier field.
